(19) United States
(12) Patent Application Publication
(10) Pub. No.: US 2026/0006397 A1
(43) Pub. Date: Jan. 1, 2026

(54) ACOUSTIC WAVE ANALYSIS METHOD, SYSTEM AND DEVICE APPLIED TO SPATIAL AUDIO

(71) Applicant: Chia-Hung Chen, New Taipei (TW)

(72) Inventors: Chia-Hung Chen, New Taipei (TW); Chia-Chi Su, Taichung (TW)

(21) Appl. No.: 19/320,282

(22) Filed: Sep. 5, 2025

Related U.S. Application Data
(63) Continuation of application No. PCT/CN2024/080303, filed on Mar. 6, 2024.
(60) Provisional application No. 63/450,105, filed on Mar. 6, 2023.

(51) Int. Cl. H04S 7/00; G01S 5/16; G01S 5/18; G01S 11/14

(52) U.S. Cl. CPC H04S 7/303; G01S 5/16; G01S 5/18; G01S 11/14

(57) ABSTRACT

The present invention provides an acoustic wave analysis method, system and device applied to spatial audio. The acoustic wave analysis method comprises the following steps: transmitting an acoustic wave signal from a transmitting end; receiving the acoustic wave signal by a receiving end to generate corresponding intensity variation information; calculating the intensity variation information by means of an algorithm to generate positioning information; and adjusting the acoustic wave signal according to the positioning information to generate an acoustic wave signal with spatial audio. In this way, a user's movement is more accurately tracked, and the audio is adjusted accordingly, thereby enhancing the user experience.

### CROSS-REFERENCE TO RELATED APPLICATION

This application is a continuation application of International Patent Application No. PCT/CN2024/080303, filed Mar. 6, 2024, which itself claims priority to U.S. provisional application No. 63/450,105, filed Mar. 6, 2023. The disclosure of each of the above applications is incorporated herein in its entirety by reference.

### FIELD OF THE INVENTION

The present invention relates to an art of analysis, particularly relating to an acoustic wave analysis method, system and device applied to spatial audio.

### BACKGROUND OF THE INVENTION

Spatial audio adjusts interaural intensity and time differences through algorithms, thereby simulating perceived direction and position of a sound source. Such audio processing technology enables a user to experience sound incoming from different perceived directions. Gyro-meters, accelerometers or other inertial measurement unit incorporated inside a headphone facilitates to dynamically track motion status of the user's head, and acoustic directivity also varies with motion status changes. Alternatively, multiple speakers or acoustic transmitters can also provide multiple channels so that stereophonic effects are created. In this way, user audio experience is improved with enhanced immersion into entertainment or work. For instance, when the user wears headphones to listen to music, the music volume and/or acoustic balancer of left and/or right ear is adjusted in correspondence with user's movement, thereby rendering the music experience more vivid. The audio processing technology can further be applied to virtual reality experiences, allowing the user to experience more natural and realistic sound, thereby rendering the process of interactive entertainment more realistic.

In the past, spatial audio tracks movement of the user's head with a combined use of gyro-meters or accelerometers in the headphones. Nonetheless, such approach requires relatively higher requests in user's behavior. For example, this approach cannot be adapted to a scenario when user's head moves too slowly or in a back-and-forth manner. With this regard, the present invention is intended to provide an acoustic wave analysis method, system and device applied to spatial audio for analyzing user's behavior based on acoustic waves so as to adjust the outputted acoustic wave signal. Such approach is not limited in any types of application, and achieves at better precision.

### SUMMARY OF THE INVENTION

One primary object of the present invention aims to provide an acoustic wave analysis method applied to spatial audio to analyze a positioning information of a user based on an acoustic wave signal, thereby enabling accurate prediction of the user's motion status and improving user experience.

One another object of the present invention aims to provide an acoustic wave analysis system applied to spatial audio. The system analyzes the user's motion status based on an acoustic wave signal by using a transforming unit, and adjusting the acoustic wave signal correspondingly so that an acoustic wave signal with spatial audio is output to enhance sound authenticity.

Yet one another object of the present invention aims to provide an acoustic wave analysis device applied to spatial audio. The device includes an output device or an electronic device serving as a transmitting source so that user's motion status can be analyzed based on an acoustic wave signal to adjust the acoustic wave signal, thereby enhancing analytic accuracy significantly.

To serve the object described hereinabove, one embodiment in the present invention discloses an acoustic wave analysis method applied to spatial audio, comprising steps of: transmitting an acoustic wave signal from a transmitting end; receiving the acoustic wave signal by a receiving end to generate a corresponding intensity variation information; calculating the intensity variation information by means of an algorithm to generate a positioning information; and adjusting the acoustic wave signal according to the positioning information to generate an acoustic wave signal with spatial audio.

Preferably, at the step of transmitting the acoustic wave signal from the transmitting end, a light source is detected to generate a corresponding light source variation information, and the transmitting end transmits the acoustic wave signal with a corresponding intensity according to the light source variation information

Preferably, at the step of calculating the intensity variation information by means of the algorithm to generate the positioning information, the algorithm performs an operation based on an inverse relationship between the intensity variation information and a distance value between the transmitting end and the receiving end so as to generate the positioning information, wherein the positioning information comprises a spatial positioning information and a displacement variation information.

Preferably, at the step of adjusting the acoustic wave signal according to the positioning information to generate the acoustic wave signal with spatial audio, a frequency drift information is generated according to a variation of the positioning information, and the frequency drift information is processed based on Doppler effect to generate an acceleration; the positioning information and the acceleration are analyzed to generate a behavior analysis information, and the acoustic wave signal is adjusted according to the behavior analysis information.

To serve one another object described hereinabove, one another embodiment in the present invention discloses an acoustic wave analysis system applied to spatial audio, comprising: a transforming unit, comprising a transmitting end and a receiving end, wherein an acoustic wave signal is transmitted from the transmitting end, and the acoustic wave signal is received by the receiving end to generate a corresponding intensity variation information; and an operation processing unit, signally connected to the transforming unit and configured to perform an operation according to the intensity variation information, thereby adjusting the acoustic wave signal, and generating an acoustic wave signal with spatial audio.

Preferably, the acoustic wave analysis system applied to spatial audio further comprises a detecting unit signally connected to the transforming unit and configured to detect a light source to generate a corresponding light source variation information, and transmitting the light source variation information to the transforming unit, wherein the transforming unit receives the light source variation information and transmits the acoustic wave signal with a corresponding intensity according to the light source variation information.

To serve yet one another object described hereinabove, yet one another embodiment in the present invention discloses an acoustic wave analysis device applied to spatial audio, comprising: a first electronic device configured to transmit an acoustic wave signal; and a first output device signally connected to the first electronic device and configured to receive the acoustic wave signal to generate a corresponding intensity variation information, and transmitting the intensity variation information to the first electronic device, wherein: the first electronic device adjusts the acoustic wave signal according to the intensity variation information to generate an acoustic wave signal with spatial audio so that the first output device outputs the acoustic wave signal with spatial audio.

To serve yet one another object described hereinabove, still one another embodiment in the present invention discloses an acoustic wave analysis device applied to spatial audio, comprising: a second electronic device configured to receive an acoustic wave signal to generate a corresponding intensity variation information, and adjusting the acoustic wave signal according to the intensity variation information to generate an acoustic wave signal with spatial audio; and a second output device signally connected to the second electronic device and configured to transmit the acoustic wave signal, and outputting the acoustic wave signal with spatial audio.

Preferably, the second output device comprises a transmitter configured to transmit the acoustic wave signal.

Preferably, the acoustic wave analysis device applied to spatial audio further comprises an optical sensor signally connected to the second output device and configured to detect a light source to generate a corresponding light source variation information, wherein: the second output device transmits the acoustic wave signal with a corresponding intensity according to the light source variation information.

The present invention achieves beneficial effects in view of improved accuracy of tracking dynamic motion status, boosting user experience, and offering an alternative solution to limited positioning technologies in the art.

### BRIEF DESCRIPTION OF THE DRAWINGS

FIG. 1A is a flowchart illustrating a method provided in one embodiment of the present invention;

FIG. 1B is a curve diagram illustrating the relationship between distance and intensity variation in one embodiment of the present invention;

FIG. 1C is a diagram illustrating the acoustic wave signal analytic results in one embodiment of the present invention;

FIG. 2 is a schematic diagram illustrating the system in one another embodiment of the present invention;

FIG. 3A is a schematic diagram illustrating the device in the first embodiment of the present invention;

FIG. 3B is a schematic diagram illustrating the device in the second embodiment of the present invention;

FIG. 4A is a schematic diagram illustrating the first exemplary embodiment in the present invention;

FIG. 4B is a schematic diagram illustrating the second exemplary embodiment in the present invention;

FIG. 4C is a schematic diagram illustrating the third exemplary embodiment in the present invention;

FIG. 4D is a schematic diagram illustrating the fourth exemplary embodiment in the present invention;

FIG. 4E is a schematic diagram illustrating the fifth exemplary embodiment in the present invention;

FIG. 4F is a schematic diagram illustrating the fifth exemplary embodiment in the present invention;

FIG. 4G is a schematic diagram illustrating the sixth exemplary embodiment in the present invention; and

FIG. 4H is a schematic diagram illustrating the sixth exemplary embodiment in the present invention.

### DETAILED DESCRIPTION OF THE INVENTION

In order to make the above and/or other objects, advantages, and features of the present invention more apparent and understandable, preferred embodiments are exemplified and described in detail below.

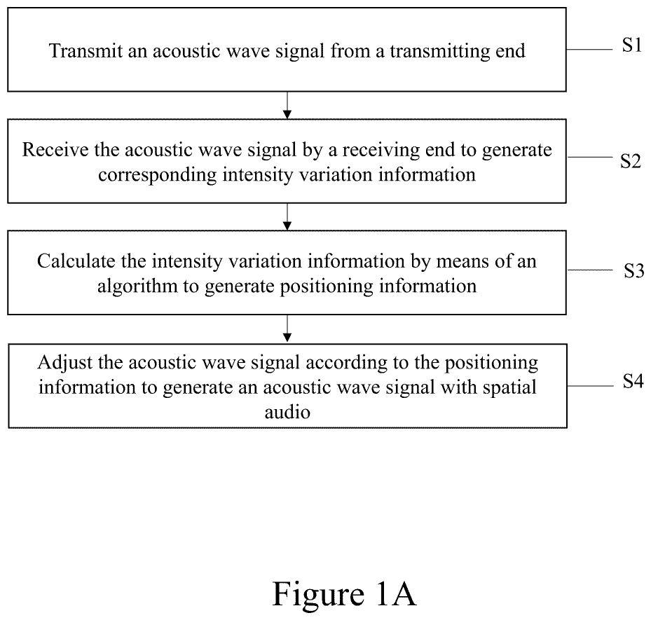

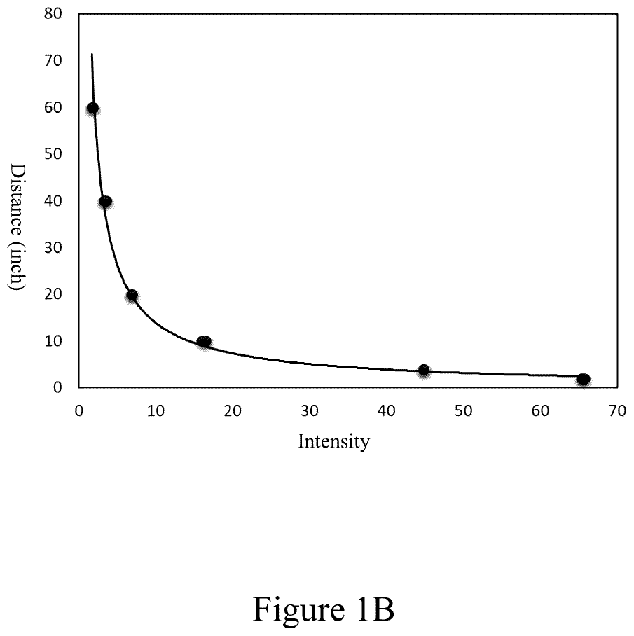

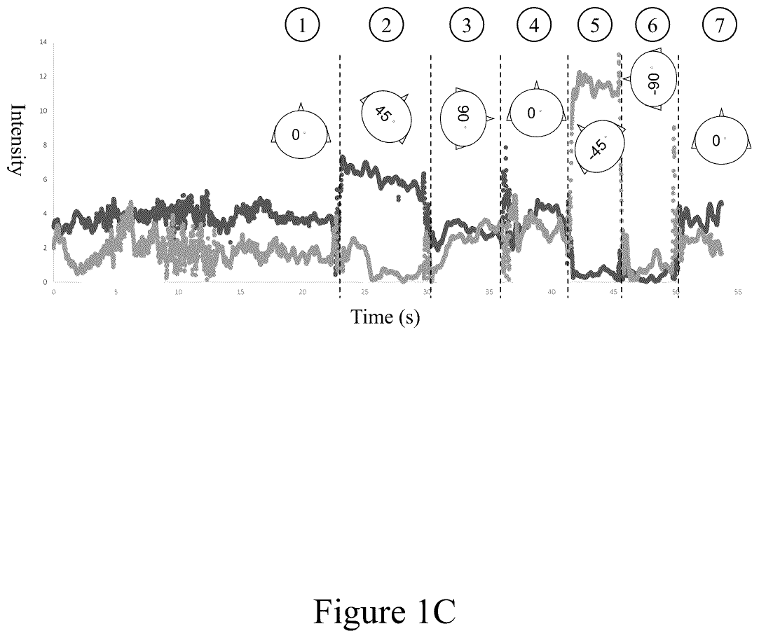

Referring to FIG. 1A illustrating a flowchart of a method provided in one embodiment of the present invention. As shown in the figure, disclosed in one embodiment of the present invention is an acoustic wave analysis method applied to spatial audio, comprising steps of:
Step S1: transmitting an acoustic wave signal from a transmitting end;
Step S2: receiving the acoustic wave signal by a receiving end to generate a corresponding intensity variation information;
Step S3: calculating the intensity variation information by means of an algorithm to generate a positioning information; and
Step S4: adjusting the acoustic wave signal according to the positioning information to generate an acoustic wave signal with spatial audio.

As indicated at the step S1, the acoustic wave signal is transmitted from the transmitting end. In one embodiment, the transmitting end may be incorporated in a smartphone, a tablet computer, a laptop computer, a personal computer or a television. Alternatively, the transmitting end may be a headphone or an ultrasonic transmitter, or any device including a speaker, but not limited to this. Specifically, a frequency range of the acoustic wave signal is 20 Hz to 2 MHz.

In one embodiment, a light source in an environment can be detected to generate a corresponding light source variation information. Namely, an environmental light variation can be detected. In this way, behavioral dynamics of the user can be predicted with reference to environmental light changes. In particular, the transmitting end transmits the acoustic wave signal with a corresponding intensity according to the light source variation information so that a behavioral state of the user can be inferred from the acoustic wave signal with various intensities.

As indicated in the step S2, the acoustic wave signal transmitted at the preceding step is received by the receiving end so as to generate a corresponding intensity variation information. In one embodiment, the receiving end may be incorporated in a smartphone, a tablet computer, a laptop computer, a personal computer or a television. Alternatively, the receiving end may be a headphone or any device equipped with a microphone, but not limited to this. Specifically, the intensity variation information is applied to analysis of a distance value between the receiving end and the transmitting end so as to analyze dynamic positioning of the user.

As indicated at the step S3, the intensity variation information is computed by means of the algorithm to generate the positioning information, wherein the algorithm performs an operation based on an inverse relationship between the intensity variation information and the distance value between the transmitting end and the receiving end. Additionally, the positioning information comprises a spatial positioning information and a displacement variation information, wherein the spatial positioning information may present the location of the receiving end, and the displacement variation information may present a distance of the receiving end displacement, or a head dynamic tracking when the receiving end is provided on the user's head.

Exemplarily, with reference to FIG. 1B illustrating the relationship between distance and intensity variation in one embodiment of the present invention. As shown in the figure, in one embodiment, the intensity variation information may be computed by Fast Fourier Transform (FFT). The intensity decreases with an increasing distance, and, on the contrary, the intensity increases with a decreasing distance. In this way, variation of the distance between the transmitting end and the receiving end can be inferred from the intensity variation information, and the positioning information is generated correspondingly.

In one embodiment, the acoustic wave signal may be received at a single point or at multiple points. In this scenario, with establishing the inverse relationship between the intensity variation information and the distance value of every single acoustic wave signal in a one-by-one manner, the spatial positioning information and the displacement variation information in real-time can be computed.

As indicated at the step S4, the acoustic wave signal is adjusted according to the positioning information obtained at the preceding step, and the acoustic wave signal with spatial audio is generated accordingly. In one embodiment, a frequency drift information can be generated based on a variation of the positioning information. The frequency drift information can be processed referring to Doppler effect, and generating an acceleration correspondingly. In this way, a behavior analysis information is generated by analyzing the positioning information and the acceleration, wherein the behavior analysis information may be dynamic tracking of the transmitting end and the receiving end when a video is played, or an interpretation of the user behavior based on the aforementioned dynamics. For instance, the behavior analysis information may indicate whether the user dozes off or leaves from the position where the video is played, but not limited to this.

In other words, user experience in perceived directions and distances is simulated based on interaural adjustment of velocity difference and volume of the sound, and an acoustic wave signal with virtual stereophonic effects is generated. Specifically, the velocity difference is extremely short, and may be several milliseconds. In this way, the audio directed to the user can be adjusted according to various behavioral patterns of the user. In particular, the adjustment may be programmed to increase or decrease acoustic volumes of different acoustic channels, but not limited to this.

Please refer to FIG. 1C presenting a diagram to illustrate the acoustic wave signal analytic results. Shown in the figure is an example of the positioning information generated by an operation based on intensity variations of the acoustic wave signal. Exemplarily, two transmitting ends are provided on the user (on user's left and right ears, respectively), and transmitting acoustic wave signal to generate corresponding intensity variation informations, respectively. As indicated, the dark grey signals represent the acoustic wave signals from the left transmitting end received by the receiving end, and the bright grey signals represent the acoustic wave signals from the right transmitting end received by the receiving end. The intensity represents the intensity variation information of the received acoustic wave signals, and designated to present a direction of rotation, divided in 7 stages from left to right. The 1^{st} stage presents initial measured values, and the 2^{nd} stage presents a state with signal intensity on the left side stronger than signal intensity on the right side. A distance variation can be inferred based on intensity variation, and such distance variation indicates a rightward rotation of 45 degrees, taking the state at the foregoing stage as reference. In view of the states at the 3^{th} and 4^{th} stages, signal intensity on the left side declines gradually to the initial signal intensity, while signal intensity on the right side increases gradually to the initial signal intensity. Additionally, the distance variations inferred based on intensity variation indicate a rightward rotation of 90 degrees, taking the initial state as reference, or the user rotates back to align with the original direction.

On the contrary, the 5^{th} stage presents a state with signal intensity on the left side weaker than signal intensity on the right side. A distance variation can be inferred based on intensity variation, and such distance variation indicates a leftward rotation of 45 degrees, taking the state at the foregoing stage as reference. In view of the states at the 6^{th} and 7^{th} stages, signal intensity on the left side gradually increases to the initial signal intensity, while signal intensity on the right side gradually declines to the initial signal intensity. In addition, the distance variations inferred based on intensity variation indicate a leftward rotation of 90 degrees, taking the initial state as reference, or the user rotates back to align with the original direction

Of note, with this approach, an analysis of user positioning information and behavioral analysis information can be performed with acoustic wave signals, and the acoustic wave signal is adjusted correspondingly, thereby rendering the sound more closely approximate reality.

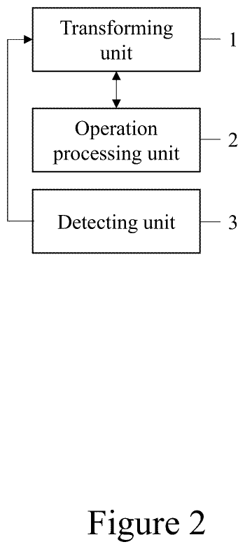

Further referring to FIG. 2 presenting a schematic diagram of the system in one embodiment. Shown in the figure is an acoustic wave analysis system applied to spatial audio in one embodiment of the present invention, comprising: a transforming unit (1), processing unit (2) and a detecting unit (3), wherein the transforming unit (1) signally connected to the processing unit (2) and the detecting unit (3), respectively, and descriptive illustrations are detailed in the followings:

The transforming unit (1) comprises a transmitting end (11) and a receiving end (12), wherein an acoustic wave signal is transmitted from the transmitting end (11). The frequency of the acoustic wave signal may be 20 Hz to 2 MHz. Namely, the transmitted acoustic wave signal may be a human-audible wave signal or an ultrasonic wave signal. The acoustic wave signal is received by the receiving end (12), and a corresponding intensity variation information is generated. Alternatively speaking, when the distance value between the transmitting end (11) and the receiving end (12) varies, intensity of the received acoustic wave signal would vary correspondingly.

The operation processing unit (2) performs an operation according to the intensity variation information, and the acoustic wave signal is adjusted accordingly so that an acoustic wave signal with spatial audio is generated. The acoustic wave signal with spatial audio is then output by the receiving end (12) of the transforming unit (1). That is to say, a more authentic sound experience can be simulated in accordance with dynamics of the receiving end (12).

The detecting unit (3) is configured to detect a light source to generate a corresponding light source variation information. The light source variation information may be changes in an environmental light, but not limited to this. The transforming unit (1) determines to transmitting the acoustic wave signal with an intensity in correspondence with the light source variation information. Alternatively speaking, the changes in status of the light source can be conveyed through the acoustic wave signal.

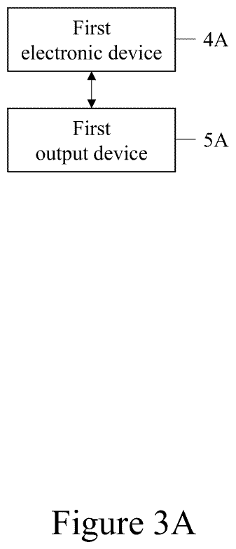

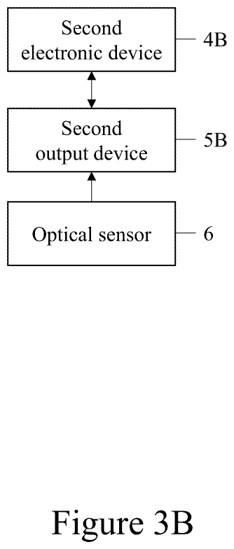

Referring to FIG. 3A presenting a schematic diagram of the device in the first embodiment of the present invention. Shown in the figure is an acoustic wave analysis device applied to spatial audio in the first embodiment of the present invention, comprising: a first electronic device (4A) and a first output device (5A), wherein the first electronic device (4A) is signally connected to the first output device (5A), and descriptive illustrations are detailed in the followings:

The first electronic device (4A) is configured to transmit an acoustic wave signal. Namely, the first electronic device (4A) serves as a transmission source. A frequency range of the acoustic wave signal is 20 Hz to 2 MHz. In one embodiment, the first electronic device (4A) may be selected from a group consisting of a smartphone, a tablet computer, a laptop computer, a personal computer and a television.

The first output device (5A) is configured to receive the acoustic wave signal transmitted from the first electronic device (4A). Namely, the first output device (5A) serves as a receiving source. In this way, a corresponding intensity variation information is obtained, and the first electronic device (4A) can adjust the acoustic wave signal according to the intensity variation information to generate an acoustic wave signal with spatial audio. The first output device (5A) outputs the acoustic wave signal with spatial audio. In one embodiment, the first output device (5A) comprises at least one speaker, such as a standard headphone, an AR or VR headphone, to allow the user to wear on both ears. The speaker is configured to output the acoustic wave signal with spatial audio, but not limited to this.

Referring to FIG. 3B presenting a schematic diagram of the device in the second embodiment of the present invention. Shown in the figure is an acoustic wave analysis device applied to spatial audio in the second embodiment of the present invention, comprising: a second electronic device (4B) and a second output device (5B), wherein the second electronic device (4B) is signally connected to the second output device (5B), and descriptive illustrations are detailed in the followings:

The second electronic device (4B) is configured to receive an acoustic wave signal transmitted from the second output device (5B). Namely, the second electronic device (4B) serves as a receiving source. In this way, a corresponding intensity variation information is obtained, and adjust the acoustic wave signal can be adjusted according to the intensity variation information to generate an acoustic wave signal with spatial audio. In one embodiment, the second electronic device (4B) may be selected from a group consisting of a smartphone, a tablet computer, a laptop computer, a personal computer and a television.

The second output device (5B) is configured to transmit an acoustic wave signal. Namely, the second output device (5B) serves as a transmission source, and outputting an acoustic wave signal with spatial audio. In one embodiment, the second output device (5B) may be a standard headphone, or, of course, an AR or VR headphone, to output the acoustic wave signal with spatial audio, thereby providing a sound with simulated stereophonic effects to the user, and offering a more realistic audio experience, but not limited to this.

In one embodiment, the second output device (5B) may include a transmitter. For example, an ultrasonic wave transmitter may be provided on the second output device (5B) to transmit the acoustic wave signal, but not limited to this.

The second embodiment differs from the first embodiment in the transmission source and the receiving source.

In one embodiment, the acoustic wave analysis device applied to spatial audio further comprises an optical sensor (6) signally connected to the second output device (5B) and configured to detect a light source to generate a light source variation information. In this way, the second output device (5B) can transmit an acoustic wave signal in correspondence with the light source variation information. In other words, acoustic wave signals with various intensity may be output according to variations in the environmental light sources, but not limited to this.

Hereinafter, several examples are provided to clearly illustrate embodiments of the present invention:

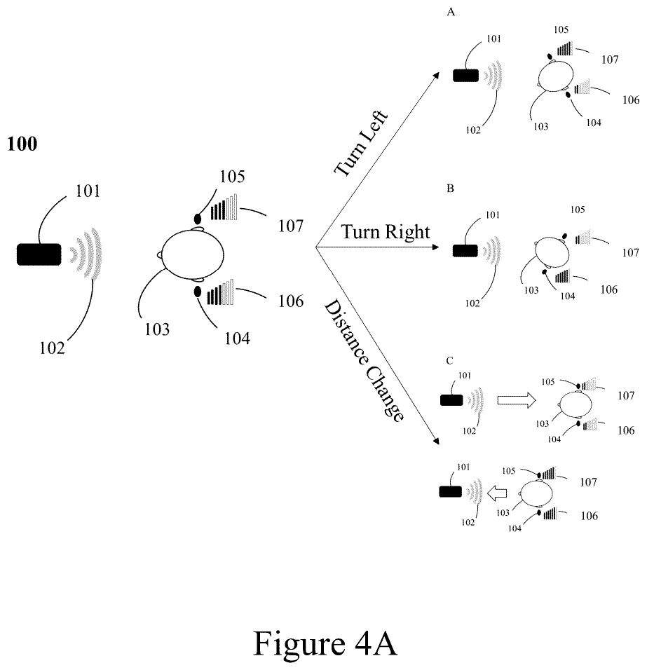

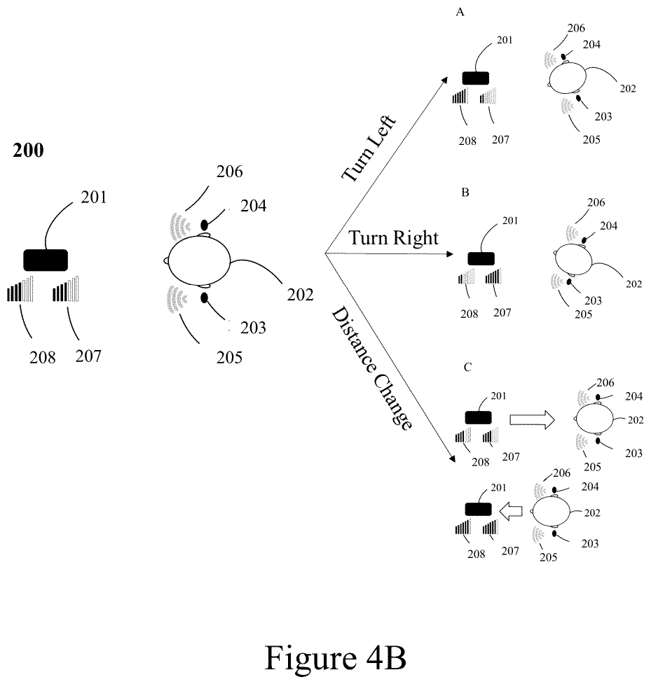

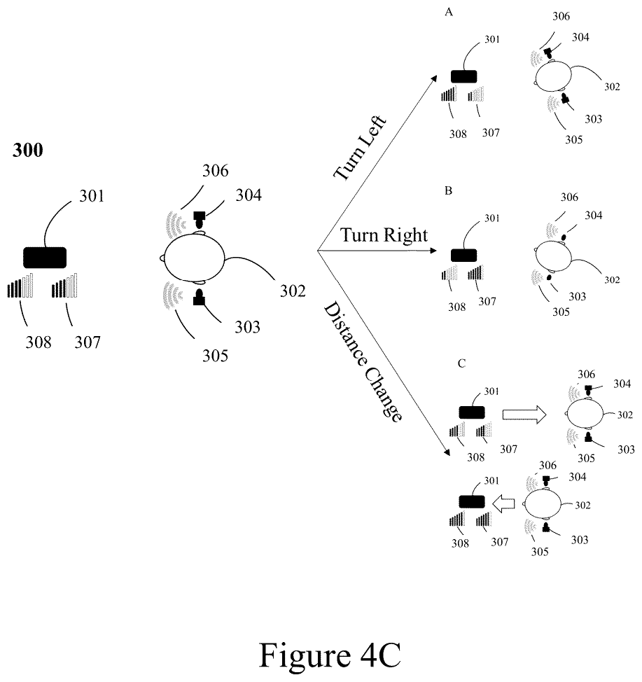

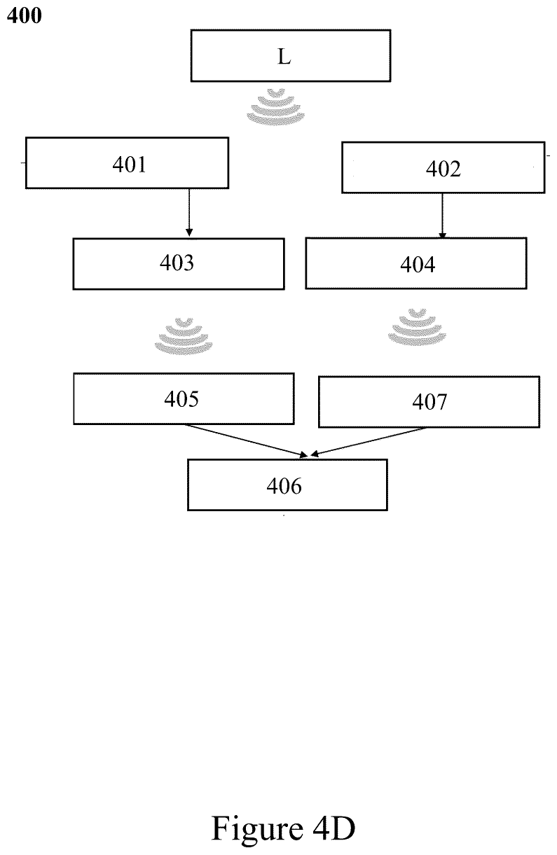

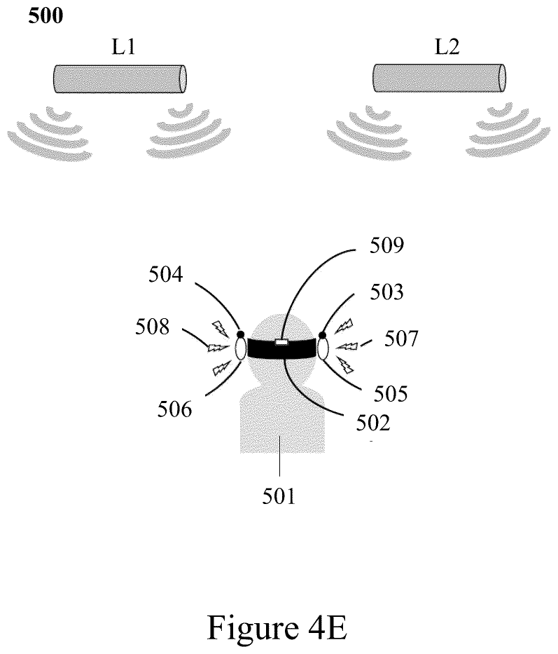

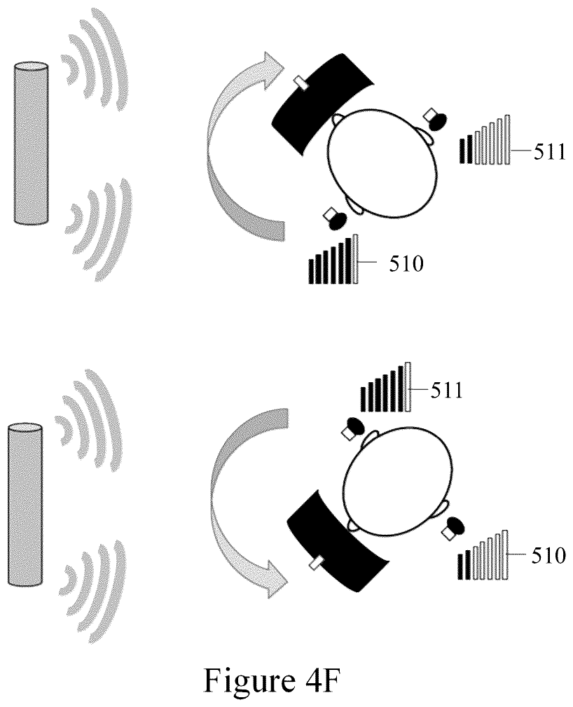

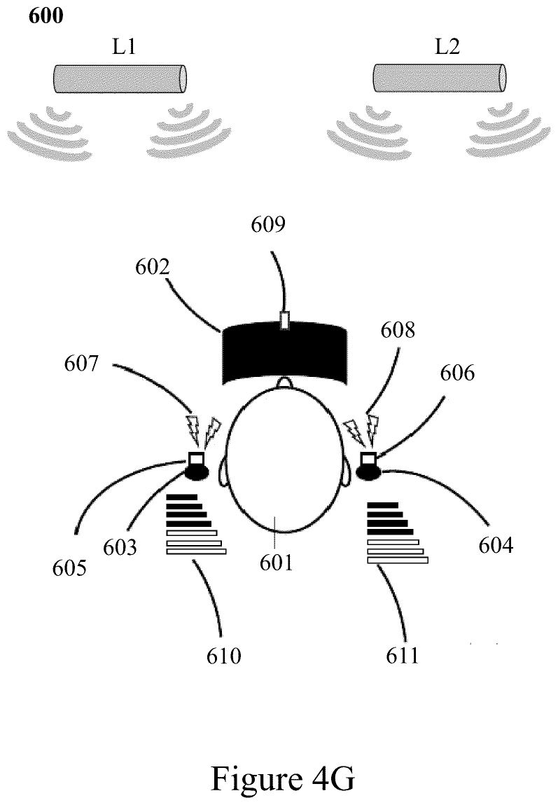

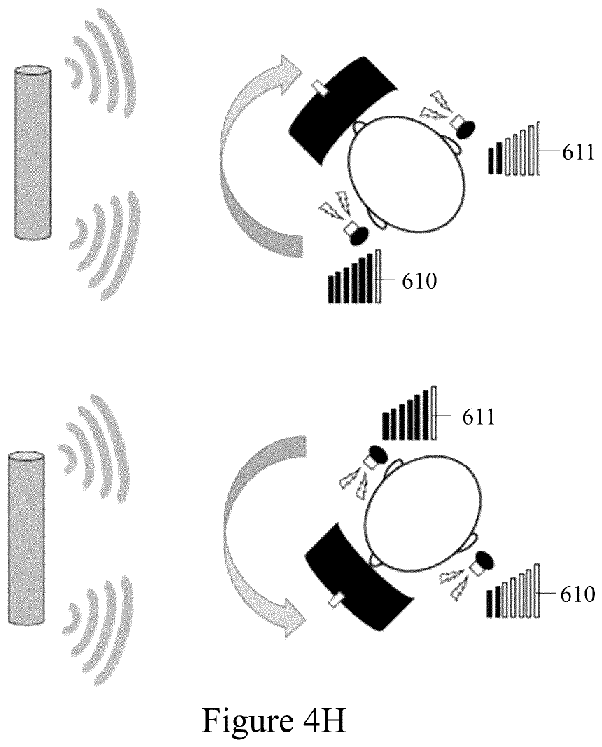

With reference to FIG. 4A presenting a schematic diagram to illustrate the first exemplary embodiment in the present invention, the first exemplary embodiment (100) transmits an acoustic wave signal (102) from the electronic device (101), and the electronic device (101) is positioned directly in front of a user (103). In this case, the user (103) wears a left earphone (104) and a right earphone (105), respectively, wherein: the left earphone (104) receives the acoustic wave signal (102) from the electronic device (101), and generating a first intensity variation information (106); in contrast, the right earphone (105) receives the acoustic wave signal (102) from the electronic device (101), and generating a second intensity variation information (107). Several implementary examples are illustrated in the followings:

Section A: when the left earphone (104) receives the first intensity variation information (106) indicating a decline, and the right earphone (105) receives the second intensity variation information (107) indicating an increase, the user's (103) head is turned leftward.

Section B: when the left earphone (104) receives the first intensity variation information (106) indicating an increase, and the right earphone (105) receives the second intensity variation information (107) indicating a decline, the user's (103) head is turned rightward.

Section C: when both the first intensity variation information (106) received by the left earphone (104) and the second intensity variation information (107) received by the right earphone (105) indicates an increase or a decline, the user (103) moves backward or forward. Alternatively speaking, distance between the user (103) and the electronic device (101) increases or decreases.

With reference to FIG. 4B presenting a schematic diagram to illustrate the second exemplary embodiment in the present invention, the second exemplary embodiment (200) receives an acoustic wave signal from the electronic device (201), and the electronic device (201) is positioned directly in front of a user (202). In this case, the user (202) wears a left earphone (203) and a right earphone (204), respectively, wherein: the left earphone (203) transmits the acoustic wave signal (205), and the right earphone (204) transmits the acoustic wave signal (206). At mean time, the electronic device (201) receives the acoustic wave signal (205) and the acoustic wave signal (206), respectively, and generating a first intensity variation information (207) and a second intensity variation information (208). Several implementary examples are illustrated in the followings:

Section A: when the first intensity variation information (207) indicates a decline, and the second intensity variation information (208) indicates an increase, the user's (202) head is turned leftward.

Section B: when the first intensity variation information (207) indicates an increase, and the second intensity variation information (208) indicates a decline, the user's (202) head is turned rightward.

Section C: when both the first intensity variation information (207) and the second intensity variation information (208) indicate an increase or a decline, the user (202) moves backward or forward. Alternatively speaking, distance between the user (202) and the electronic device (201) increases or decreases.

With reference to FIG. 4C presenting a schematic diagram to illustrate the third exemplary embodiment in the present invention, the third exemplary embodiment (300) receives an acoustic wave signal from the electronic device (301), and the electronic device (301) is positioned directly in front of a user (302). In this case, the user (302) is provided with a left transmitter (303) and a right transmitter (304), respectively, wherein: the left transmitter (303) transmits an acoustic wave signal (305) and the right transmitter (304) transmits an acoustic wave signal (306). At mean time, the electronic device (301) receives the acoustic wave signal (305) and the acoustic wave signal (306), respectively, and generating a first intensity variation information (307) and a second intensity variation information (308). Several implementary examples are illustrated in the followings:

Section A: when the first intensity variation information (307) indicates a decline, and the second intensity variation information (308) indicates an increase, the user's (302) head is turned leftward.

Section B: when the first intensity variation information (307) indicates an increase, and the second intensity variation information (308) indicates a decline, the user's (302) head is turned rightward.

Section C: when both the first intensity variation information (307) and the second intensity variation information (308) indicate an increase or a decline, the user (302) moves backward or forward. Alternatively speaking, distance between the user (302) and the electronic device (301) increases or decreases.

With reference to FIG. 4D presenting a schematic diagram to illustrate the fourth exemplary embodiment in the present invention, the fourth exemplary embodiment (400) is further configured with an optical sensor including a left-sided optical sensor (401) and a right-sided optical sensor (402). In this case, the user wears the left-sided transmitter (403) and the right-sided transmitter (404). When a light source (L) irradiates on the left-sided optical sensor (401) and the right-sided optical sensor (402), the left-sided optical sensor (401) outputs a first light source variation information to the left-sided transmitter (403) so that the left-sided transmitter (403) transmits an acoustic wave signal with a corresponding intensity (405) to the electronic device (406). Similarly, the right-sided optical sensor outputs a second light source variation information to the right-sided transmitter (404) so that the right-sided transmitter (404) transmits an acoustic wave signal with a corresponding intensity (407) to the electronic device (406). Through an operation performed by the electronic device (406), a behavior analysis information corresponding to the user can be obtained, and the outputted acoustic wave signal is adjusted correspondingly.

With reference to FIGS. 4E to 4F presenting schematic diagrams to illustrate the fifth exemplary embodiment in the present invention, the fifth exemplary embodiment (500) is further configured with multiple light sources (L1, L2). In this case, the user (501) wears an AR or VR headphone (502), and provided with a left-sided optical sensor (503), a right-sided optical sensor (504), a left-sided ultrasonic wave transmitter (505), and a right-sided ultrasonic wave transmitter (506), respectively. When a light source (L) irradiates on the left-sided optical sensor (503) and the right-sided optical sensor (504), the left-sided optical sensor (503) outputs a first light source variation information to the left-sided ultrasonic wave transmitter (505) so that the left-sided ultrasonic wave transmitter (505) transmits an acoustic wave signal (507) with a corresponding intensity. Similarly, the right-sided optical sensor (504) outputs a second light source variation information to the right-sided ultrasonic wave transmitter (506) so that the right-sided ultrasonic wave transmitter (506) transmits an acoustic wave signal (508) with a corresponding intensity, wherein the frequency ranges of the acoustic wave signal (507) and the acoustic wave signal (508) are both greater than 20 kHz.

As shown in FIG. 4F, when the receiver (509) of the AR or VR headphone (502) receives the acoustic wave signal (507) from the left side and the acoustic wave signal (508) from the right side, a first intensity variation information (510) and a second intensity variation information (511) are generated correspondingly in a respective manner. Thus, when the first intensity variation information (510) is larger than the second intensity variation information (511), the user turns right. Conversely, when the first intensity variation information (511) is smaller than the second intensity variation information (511), the user turns left.

In one embodiment, the left-sided optical sensor (503) and the right-sided optical sensor (504) may be positioned on both ears or on both sides of the head so as to confirm light source variation in the position. In order to obtain the corresponding behavior analysis information more precisely, the head may rotate at different angles or in different directions, and the light source variation information varying accordingly is recorded as samples for the behavior analysis information. Additionally, data collected by an inertial sensor such as a gyro-meter and an accelerometer may also be combined to the samples for the behavior analysis information. Exemplarily, the data includes information about a dimension or a direction of a certain movement, but not limited to this.

With reference to FIGS. 4G to 4H presenting schematic diagrams to illustrate the sixth exemplary embodiment in the present invention, the sixth exemplary embodiment (600) is further configured with multiple light sources (L1, L2). In this case, the user (601) wears an AR or VR headphone (602), and provided with a left-sided optical sensor (603), a right-sided optical sensor (604), a left-sided ultrasonic wave transmitter (605), and a right-sided ultrasonic wave transmitter (606), respectively. When a light source (L) irradiates on the left-sided optical sensor (603) and the right-sided optical sensor (604), the left-sided optical sensor (603) outputs a first light source variation information to the left-sided ultrasonic wave transmitter (605) so that the left-sided ultrasonic wave transmitter (605) transmits an acoustic wave signal (607) with a corresponding intensity. Similarly, the right-sided optical sensor (604) outputs a second light source variation information to the right-sided ultrasonic wave transmitter (606) so that the right-sided ultrasonic wave transmitter (606) transmits an acoustic wave signal (608) with a corresponding intensity. Of note, the sixth exemplary embodiment outputs varying acoustic wave signals because variation in light also represents a movement, while the fifth exemplary embodiment directly relies on the acoustic wave signal as a reference for measuring a distance. Moreover, both the sixth exemplary embodiment and fifth exemplary embodiments may also be implemented on a single device using acoustic waves with different frequencies simultaneously, thereby enabling verification and more accurate calculation.

As shown in FIG. 4H, the receiver (609) of the AR or VR headphone (602) receives the acoustic wave signal (607) from the left side and the acoustic wave signal (608) from the right side, and generating the first intensity variation information (610) and the second intensity variation information (611) correspondingly in a respective manner. With this approach, the receiver (609) may infer light source intensity variations of the left-sided optical sensor (603) and the right-sided optical sensor (604), correspondingly, from the first intensity variation information (610) and the second intensity variation information (611), thereby realizing dynamic head tracking of the spatial audio.

In sum, the present invention provides an acoustic wave analysis method, system and device applied to spatial audio. By using acoustic wave signals in dynamic behavior analysis of a user, accuracy of the behavior analysis is improved, and user audio experience is also enhanced. Limitations in current technologies of positioning are therefore overcome, and objects of the present invention are also achieved.

What is claimed is:

1. An acoustic wave analysis method applied to spatial audio, comprising steps of:
transmitting an acoustic wave signal from a transmitting end;
receiving the acoustic wave signal by a receiving end to generate a corresponding intensity variation information;
calculating the intensity variation information by means of an algorithm to generate a positioning information; and
adjusting the acoustic wave signal according to the positioning information to generate an acoustic wave signal with spatial audio.

2. The acoustic wave analysis method applied to spatial audio according to claim 1, wherein: at the step of transmitting the acoustic wave signal from the transmitting end, a light source is detected to generate a corresponding light source variation information, and the transmitting end transmits the acoustic wave signal with a corresponding intensity according to the light source variation information.

3. The acoustic wave analysis method applied to spatial audio according to claim 1, wherein: at the step of calculating the intensity variation information by means of the algorithm to generate the positioning information, the algorithm performs an operation based on an inverse relationship between the intensity variation information and a distance value between the transmitting end and the receiving end so as to generate the positioning information, wherein the positioning information comprises a spatial positioning information and a displacement variation information.

4. The acoustic wave analysis method applied to spatial audio according to claim 1, wherein: at the step of adjusting the acoustic wave signal according to the positioning information to generate the acoustic wave signal with spatial audio, a frequency drift information is generated according to a variation of the positioning information, and the frequency drift information is processed based on Doppler effect to generate an acceleration; the positioning information and the acceleration are analyzed to generate a behavior analysis information, and the acoustic wave signal is adjusted according to the behavior analysis information.

5. The acoustic wave analysis method applied to spatial audio according to claim 1, wherein the intensity variation information is computed by Fast Fourier Transform (FFT); a frequency range of the acoustic wave signal is 20 Hz to 2 MHz.

6. The acoustic wave analysis method applied to spatial audio according to claim 1, wherein:
at the step of transmitting the acoustic wave signal from the transmitting end, a light source is detected to generate a corresponding light source variation information, and the transmitting end transmits the acoustic wave signal with a corresponding intensity according to the light source variation information; and
at the step of calculating the intensity variation information by means of the algorithm to generate the positioning information, the algorithm performs an operation based on an inverse relationship between the intensity variation information and a distance value between the transmitting end and the receiving end so as to generate the positioning information, wherein the positioning information comprises a spatial positioning information and a displacement variation information.

7. The acoustic wave analysis method applied to spatial audio according to claim 6, wherein the intensity variation information is computed by Fast Fourier Transform (FFT); a frequency range of the acoustic wave signal is 20 Hz to 2 MHz.

8. The acoustic wave analysis method applied to spatial audio according to claim 1, wherein:
at the step of transmitting the acoustic wave signal from the transmitting end, a light source is detected to generate a corresponding light source variation information, and the transmitting end transmits the acoustic wave signal with a corresponding intensity according to the light source variation information; and
at the step of adjusting the acoustic wave signal according to the positioning information to generate the acoustic wave signal with spatial audio, a frequency drift information is generated according to a variation of the positioning information, and the frequency drift information is processed based on Doppler effect to generate an acceleration; the positioning information and the acceleration are analyzed to generate a behavior analysis information, and the acoustic wave signal is adjusted according to the behavior analysis information.

9. The acoustic wave analysis method applied to spatial audio according to claim 8, wherein the intensity variation information is computed by Fast Fourier Transform (FFT); a frequency range of the acoustic wave signal is 20 Hz to 2 MHz.

10. The acoustic wave analysis method applied to spatial audio according to claim 1, wherein:
at the step of transmitting the acoustic wave signal from the transmitting end, a light source is detected to generate a corresponding light source variation information, and the transmitting end transmits the acoustic wave signal with a corresponding intensity according to the light source variation information;
at the step of calculating the intensity variation information by means of the algorithm to generate the positioning information, the algorithm performs an operation based on an inverse relationship between the intensity variation information and a distance value between the transmitting end and the receiving end so as to generate the positioning information, wherein the positioning information comprises a spatial positioning information and a displacement variation information; and
at the step of adjusting the acoustic wave signal according to the positioning information to generate the acoustic wave signal with spatial audio, a frequency drift information is generated according to a variation of the positioning information, and the frequency drift information is processed based on Doppler effect to generate an acceleration; the positioning information and the acceleration are analyzed to generate a behavior analysis information, and the acoustic wave signal is adjusted according to the behavior analysis information.

11. The acoustic wave analysis method applied to spatial audio according to claim 10, wherein the intensity variation information is computed by Fast Fourier Transform (FFT); a frequency range of the acoustic wave signal is 20 Hz to 2 MHz.

12. An acoustic wave analysis system applied to spatial audio, comprising:
a transforming unit, comprising a transmitting end and a receiving end, wherein an acoustic wave signal is transmitted from the transmitting end, and the acoustic wave signal is received by the receiving end to generate a corresponding intensity variation information; and
an operation processing unit, signally connected to the transforming unit and configured to perform an operation according to the intensity variation information, thereby adjusting the acoustic wave signal, and generating an acoustic wave signal with spatial audio.

13. The acoustic wave analysis system applied to spatial audio according to claim 12, further comprising a detecting unit signally connected to the transforming unit and configured to detect a light source to generate a corresponding light source variation information, and transmitting the light source variation information to the transforming unit, wherein the transforming unit receives the light source variation information and transmits the acoustic wave signal with a corresponding intensity according to the light source variation information.

14. The acoustic wave analysis system applied to spatial audio according to claim 12, wherein the intensity variation information is computed by Fast Fourier Transform (FFT); wherein a frequency range of the acoustic wave signal is 20 Hz to 2 MHz.

15. An acoustic wave analysis device applied to spatial audio, comprising:
a first electronic device configured to transmit an acoustic wave signal; and
a first output device signally connected to the first electronic device and configured to receive the acoustic wave signal to generate a corresponding intensity variation information, and transmitting the intensity variation information to the first electronic device, wherein:
the first electronic device adjusts the acoustic wave signal according to the intensity variation information to generate an acoustic wave signal with spatial audio so that the first output device outputs the acoustic wave signal with spatial audio.

16. The acoustic wave analysis device applied to spatial audio according to claim 15, wherein the intensity variation information is computed by Fast Fourier Transform (FFT); wherein a frequency range of the acoustic wave signal is 20 Hz to 2 MHz.

17. An acoustic wave analysis device applied to spatial audio, comprising:
a second electronic device configured to receive an acoustic wave signal to generate a corresponding intensity variation information, and adjusting the acoustic wave signal according to the intensity variation information to generate an acoustic wave signal with spatial audio; and
a second output device signally connected to the second electronic device and configured to transmit the acoustic wave signal, and outputting the acoustic wave signal with spatial audio.

18. The acoustic wave analysis device applied to spatial audio according to claim 17, wherein the second output device comprises a transmitter configured to transmit the acoustic wave signal.

19. The acoustic wave analysis device applied to spatial audio according to claim 17, further comprising an optical sensor signally connected to the second output device and configured to detect a light source to generate a corresponding light source variation information, wherein: the second output device transmits the acoustic wave signal with a corresponding intensity according to the light source variation information.

20. The acoustic wave analysis device applied to spatial audio according to claim 17, wherein the intensity variation information is computed by Fast Fourier Transform (FFT); wherein a frequency range of the acoustic wave signal is 20 Hz to 2 MHz.
